(19) United States
(12) Patent Application Publication
(10) Pub. No.: US 2009/0174633 A1
(43) Pub. Date: Jul. 9, 2009

(54) ORGANIC LIGHT EMITTING DIODE IDENTIFICATION BADGE

(76) Inventor: David Bruce Kumhyr, Austin, TX (US)

Correspondence Address: IBM CORP (YA);C/O YEE & ASSOCIATES PC, P.O. BOX 802333, DALLAS, TX, 75380, US

(21) Appl. No.: 11/971,249

(22) Filed: Jan. 9, 2008

(51) Int. Cl. G09G 3/32

(52) U.S. Cl. 345/82

(57) ABSTRACT

An organic light-emitting diode (OLED) display device used as an identifier of an entity, person, or user access level in an identification badge. With the illustrative embodiments, the access and/or identifying information displayed on the badge can be altered or concealed as needed. The identification badge comprises at least one OLED display device for displaying identification information about a user associated with the identification badge. The identification badge also comprises one or more buttons affixed to the identification badge for selection by the user. User selection of a first button on the identification badge conceals visibility of the identification information displayed in the OLED display device. User selection of a second button on the identification badge enables the identification information concealed from display in the OLED display device to become visible again.

### BACKGROUND OF THE INVENTION

1. Field of the Invention

The present invention relates generally to an organic light-emitting diode display device. In particular, the present invention relates to an organic light-emitting diode display device used as an identifier of an entity, person, or user access level in an identification badge.

2. Description of the Related Art

Identification badges are in general use because of the need to discriminate between authorized and unauthorized persons and between employees and non-employees, as well as other groups. Identification badges typically include employee identification cards or secure area identification cards which are used in locations such as schools, workplaces, and government buildings, among others. An identification badge is commonly a card comprising an image of the card user and other identifying information, such as the name of the user and the issuer of the card. Credentials displayed on an identification badge may be changed in appearance occasionally for security reasons.

When facilities or businesses desire to maintain a secure access control system for vital areas, identification badges may be employed to control access to secure areas and to restrict the use of certain secure pieces of equipment. The identification badge is often presented to security personnel as verification that a badge wearer is authorized to take certain actions or enter certain areas. While a typical identification badge displays information about the user's access level or identity, there are times when the information displayed on the badge is not needed, or, in other cases, the user does not want the information on the badge to be displayed. For example, a user having an identification badge which gives him access to a secure area of a facility does not need to have the access-level information on the badge displayed when the user is outside of the secure area (e.g., when the employee leaves the facility after work or during a lunch break). In addition, the user may not want his identifying information (name, workplace, etc.) viewable to others outside of the secure area. In another example, police officers typically wear identification badges made of highly reflective metal. In certain situations, however, a police officer may not want his reflective identification badge to be visible by others, such as when the officer is working at night in a tactical situation.

Therefore, it would be beneficial to have an improved identification badge representing the wearer's identity and/or level of access that that wearer may easily alter or conceal the wearer's access and/or identity information as needed.

### SUMMARY OF THE INVENTION

The illustrative embodiments provide an organic light-emitting diode (OLED) display device used as an identifier of an entity, person, or user access level in an identification badge. With the illustrative embodiments, the access and/or identifying information displayed on the badge can be altered or concealed as needed. The identification badge comprises at least one OLED display device for displaying identification information about a user associated with the identification badge. The identification badge also comprises one or more buttons affixed to the identification badge for selection by the user. User selection of a first button on the identification badge conceals visibility of the identification information displayed in the OLED display device. User selection of a second button on the identification badge enables the identification information concealed from display in the OLED display device to become visible again.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a common organic light emitting diode device with which the illustrative embodiments may be implemented;

FIG. 2 is a pictorial representation of an exemplary building containing a secure area in which illustrative embodiments may be implemented;

FIG. 3 is an exemplary illustration of an identification badge comprising an organic light emitting diode display device in accordance with the illustrative embodiments;

FIG. 4 is a block diagram of a system in which identification information displayed in the identification badge may be stored and modified in accordance with the illustrative embodiments;

FIG. 5 is a block diagram of an example architecture for the identification badge in accordance with the illustrative embodiments; and

FIG. 6 is a block diagram of an example architecture for the computing device in accordance with the illustrative embodiments.

### DETAILED DESCRIPTION OF THE PREFERRED EMBODIMENT

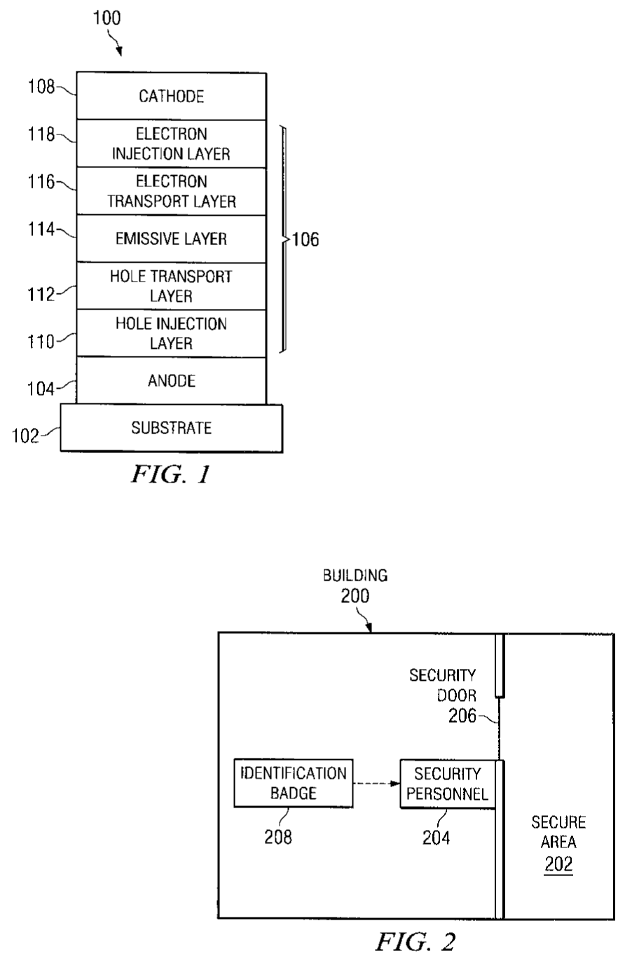

With reference now to the figures and in particular with reference to FIG. 1, a diagram of a common OLED device with which the illustrative embodiments may be implemented is shown. OLED display devices are known in the art. An OLED is a solid-state device composed of thin films of organic molecules that create light with the application of electricity. In OLED displays, a series of organic thin films are placed between two electrodes, i.e., an anode and a cathode, to combine electrons and holes to form images. When electrical current is applied to a plurality of layers interposed between the two electrodes, a bright light is emitted in a process called electrophosphorescence. Because OLED displays are light-emitting display devices, they require no light source and have low power consumption. OLEDs can provide brighter displays, use less power, and are lighter in weight than liquid crystal displays (LCDs) and conventional LEDs.

Common OLED device 100 is shown to comprise substrate 102, anode 104, organic structure 106, and cathode 108. Substrate 102 is used to support the OLED structure and may comprise clear plastic, glass, etc. Transparent anode 104 is disposed on substrate 102. An organic light emitting structure 106 is formed between anode 104 and a cathode 108. Organic light emitting structure 106 comprises hole injection layer 110, hole transport layer 112, emissive layer 114, electron transport layer 116, and electron injection layer 118. When an appropriate voltage is applied to the cell, cathode 108 will inject electrons into the electron transport layer 116, and the electrons migrate across electron transport layer 116 to the emissive layer 114. At the same time, holes are injected from anode 104 into hole transport layer 112. The holes migrate across hole transport layer 112 and recombine with electrons at or near a junction formed between hole transport layer 112 and emissive layer 114. When a migrating electron drops from its conduction band to a valance band in filling a hole, energy is released as visible light, which is emitted through anode 104 and substrate 102.

The illustrative embodiments provide an OLED display device used as an identifier of an entity, person, or user access level in which the access and/or identifying information displayed on the badge can be altered or concealed as needed. The OLED display device comprises an identification badge that may be presented to security personnel as verification that a badge wearer is authorized to take certain actions or enter certain areas. The OLED identification badge allows a user to gain access to a secure area of a facility, while allowing the user to control the display on the OLED identification badge. The user may easily alter the OLED display on the identification badge to show the wearer's identity information or access level when needed, and the user may conceal the display of his access or identity information on the badge when the user does not need or want the information to be shown. For example, in certain circumstances, such as when outside of the secure facility, the user may select to conceal the identification information displayed on the badge.

FIG. 2 is a pictorial representation of an exemplary embodiment of a building containing a secure area is shown in which illustrative embodiments may be implemented. Building 200 may be any type building in which restricted access is required into a secure area. Building 200 includes secure area 202, security personnel 204, and security door 206.

However, it should be noted that building 200 is only intended for illustration purposes and is not meant as an architectural limitation on illustrative embodiments. For example, building 200 may contain a plurality of secure areas, access data processing systems, security device scanner units and security doors. In addition, building 200, itself, may be an entirely secure area.

Secure area 202 may be any type of vital area requiring that access be restricted to only authorized individuals. When presented with identification badge 208, security personnel 204 reads the display on identification badge 208. An authorized individual may use identification badge 208 to gain access to secure area 202. Security door 206 may be any suitable obstacle, such as a door, gate, or vault, capable of preventing unauthorized access to secure area 202.

In accordance with the illustrative embodiments, identification badge 208 comprises an OLED display device, such as OLED device 100 in FIG. 1. The OLED display on identification badge 208 is used to display the identity of the badge wearer or the access level of the badge wearer. Access and/or identifying information displayed on the badge can be altered or concealed as needed.

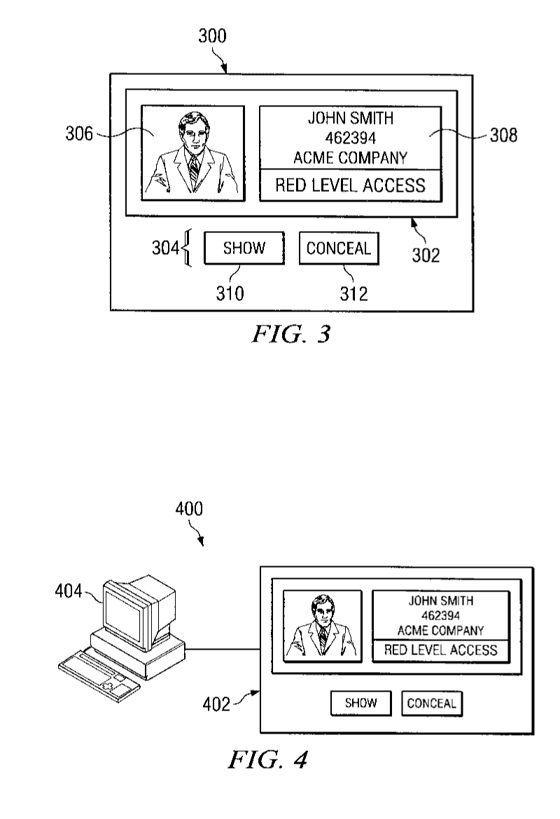

FIG. 3 is an exemplary illustration of an embodiment of an identification badge in accordance with the illustrative embodiments. Identification badge 300 may be carried by a user or worn by the user, such as with a lanyard, or be fastened to an article of the user's clothing, such as with a safety pin. In this illustrative example, identification badge 300 is shown to comprise an OLED display device 302, as well as one or more buttons 304. Identification badge 300 also comprises a power source (not shown), such as a battery or a solar cell, which is used to supply power to OLED display device 302.

OLED display device 302 is an example of OLED device 100 in FIG. 1. OLED display device 302 is adapted to display information such as, for example, identification information about the user to which the badge is associated. This identification information may be, for example, letters, numbers, symbols, pictures, or any combination thereof. This identification information may also consist of a particular color or color combinations. The specific size and configuration of the identification badge, the OLED display device, and buttons on the identification badge may vary. OLED display device 302 may comprise textual images, graphical images, or a combination of both. In this example, OLED display device 302 on identification badge 300 includes a graphical image 306 of the badge user. Graphical image 306 may include other images associated with the user, such as a fingerprint image. Identification badge 300 also includes textual images 308 which indicate identifying information about the user, such as the user's name, employee identifier/number, company name, etc. Graphical image 306 and textual images 308 may also be used to indicate an access level of the user. For example, text on OLED display device 302 may be used to specify the user's access level (e.g., level 1, 2, etc.). In another example, the colors used in graphical image 306 and/or textual images 308 may be used to indicate the user's access level (green may indicate a high-level security clearance, while red may indicate a low-level security clearance, etc).

Buttons 304 on identification badge 300 may be used by the badge user to show, conceal, or alter the identification information displayed on OLED display device 302. Buttons 304 may include, for example, show button 310 or conceal button 312. Show button 310 permits the user to select an option which allows identification information of the badge user to be shown in OLED display device 302. In this manner, user selection of show button 310 allows the user to show or “turn on” the display of the user's identification information in OLED display device 302 when needed, such as when the user requires access to a secure facility, such as secure area 202 in FIG. 2. As a result, security personnel will be able to view and/or read the identification information displayed on OLED display device 302 to determine the identity of security access level of the badge user.

In contrast, conceal button 312 permits the user to select an option which allows identification information of the badge user to be concealed in OLED display device 302. When conceal button 312 is selected by the user, the user may conceal the display of the user's identification information in OLED display device 302 when needed, such as when the user does not want the information on the badge to be displayed to others. Concealing the identification information on the display may include turning off OLED display device 302 completely, such that OLED display device 302 does not display any information, or altering the display of OLED display device 302, such that the identification information displayed is merely obscured from a viewer. For example, the entire display of OLED display device 302 may be altered to display the same color light as the light used in displaying the identification information. As a result, the identification information on the badge will be obscured from others.

It should be noted that show button 310 and conceal button 312 may also be used to show or conceal certain sections of the identification information displayed on OLED display device 302. Show button 310 and conceal button 312 may also be configured within one selectable button, such that identification information may be displayed or hidden using a show/conceal toggle button. Other buttons comprising additional features may be provided on identification badge 300 based upon desired functionality. For example, in another embodiment, a selectable button may be provided on identification badge 300 which enables OLED display device 302 to display access levels and/or the identification of the badge wearer for only a set length of time. When the time limit expires, the OLED display device 302 will conceal the identification information on identification badge 300.

FIG. 4 is a block diagram of a system in which identification information displayed in the identification badge may be stored and modified in accordance with the illustrative embodiments. System 400 comprises identification badge 402 and a computing device 404. Identification badge 402 is an example of identification badge 300 in FIG. 3. Computing device 404 may be a desktop computer, a laptop computer, personal digital assistant (PDA), or any other device capable of receiving and storing identity or security access information from a user input. Computing device 404 may communicate with identification badge 402 via wired or wireless communications links. Wireless communications may include radio frequency communications or infrared communications, as well as short-range transmissions, such as, for example, very low power radio frequency (RF), wireless fidelity (Wi-Fi), and Bluetooth. Wi-Fi refers to a set of I.E.E.E. standards, 802.11a and 802.11b, for wireless transmissions. Bluetooth is a wireless personal area network (PAN) technology from the Bluetooth Special Interest Group. Bluetooth is an open standard for short-range transmission of digital voice and data between mobile devices (laptops, personal digital assistants (PDAs), phones) and desktop devices.

Using these communications links, computing device 404 may provide updated or modified identity information to identification badge 402 as needed. For example, when a user's security access level changes, computing device 404 may send the updated security credential information to identification badge 402 to enable identification badge 402, upon receipt of the security credential changes, to display the proper security access level for the user in the OLED display device. In addition, the overall appearance of identity information displayed on the OLED display device may be changed periodically for security purposes. Computing device 404 may send such display changes to identification badge 402 as required.

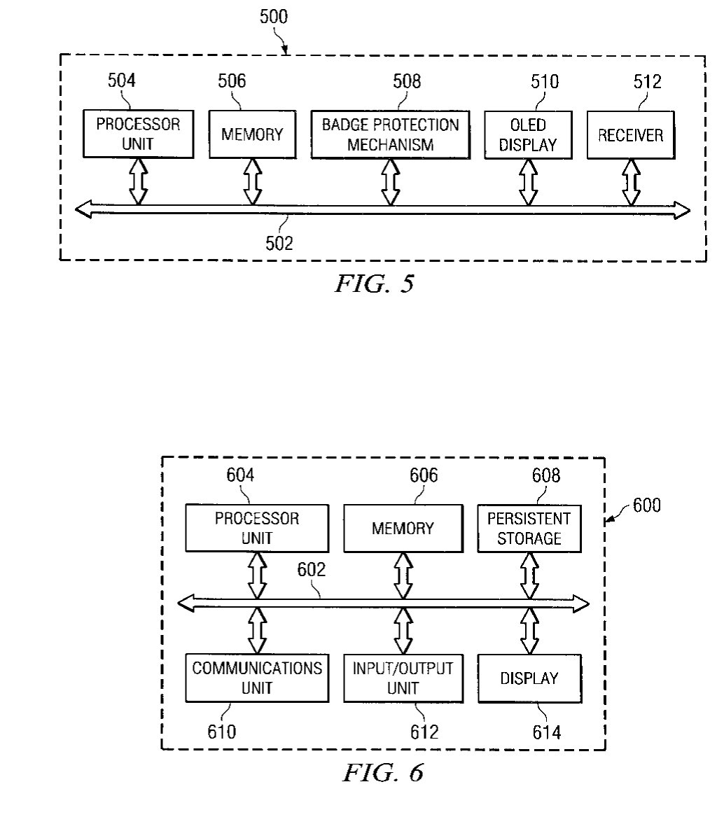

FIG. 5 is a block diagram of an example architecture for an identification badge in accordance with the illustrative embodiments. Identification badge 500 is an example of identification badge 300 in FIGS. 3 and 402 in FIG. 4. In this example, identification badge 500 includes communications fabric 502, processor unit 504, memory 506, badge lock mechanism 508, and OLED display 510.

Processor unit 504 executes software instructions that may be loaded into memory 506. Memory 506 may be, for example, a random access memory or any other suitable volatile or non-volatile storage device. Memory 506 comprises an operating system which controls the information displayed on OLED display 510 on identification badge 500. For instance, when a user input to show or conceal the identity information displayed on the badge is received (e.g., when the user selects the show or conceal button on identification badge 500), the information displayed on OLED display 510 may be changed accordingly. If instructions for updating the identity information on the badge are received from computing device 404 in FIG. 4, these instructions are also stored in memory 506. Processor unit may then execute these instructions to update the identity information displayed in the OLED display 510 on identification badge 500.

Badge protection mechanism 508 serves to protect identification badge 500 from unauthorized access. For example, the user of identification badge 500 or a person who gains possession of identification badge 500 should not be allowed to alter the identification information displayed in the OLED display 510 without authorization to do so. Otherwise, a user would be able to change the identification information displayed to potentially give themselves a higher security access level than the level authorized to the user, or an unauthorized person who gains possession of the badge may alter the name or photo image on the badge to match his own name and image. The term “mechanism” is intended to include all possible implementations (such as electronic hardware, computer implemented software, hybrids, or the like) or the process performed. Badge protection mechanism 508 may comprise a mechanism for password protecting the identification data stored in memory 506, such that only a user with the proper password may access the badge and update or change the identity information. Badge protection mechanism 508 may also include encrypting the identification data stored in memory 506 so that the content of the data cannot be determined until the data is decrypted with the proper cryptographic key. In this manner, the identification information on identification badge 500 may be secured from being changed or altered by an unauthorized user.

In one embodiment, identification badge 500 receives communications from other computing devices via a wired communication link. In this embodiment, identification badge 500 may comprise a port outlet (not shown) to which a plug or cable is connected to another computing device. Instructions for updating or changing identity information may be sent from the computing device to identification badge 500 using the wired communication link. In another embodiment, identification badge 500 receives communications from other computing devices via a wireless communication link, such as via RF or infrared communications. In this embodiment, receiver 512 serves to receive wireless communications from the other computing devices, such as computing device 404 in FIG. 4.

FIG. 6 is a block diagram of an example architecture for a computing device in accordance with the illustrative embodiments. Computing device 600 is an example of computing device 404 in FIG. 4. In this illustrative example, computing device 600 includes communications fabric 602, which provides communications between processor unit 604, memory 606, persistent storage 608, communications unit 610, input/output (I/O) unit 612, and display 614.

Processor unit 604 serves to execute instructions for software that may be loaded into memory 606. Processor unit 604 may be a set of one or more processors or may be a multi-processor core, depending on the particular implementation. Further, processor unit 604 may be implemented using one or more heterogeneous processor systems in which a main processor is present with secondary processors on a single chip. As another illustrative example, processor unit 604 may be a symmetric multi-processor system containing multiple processors of the same type.

Memory 606, in these examples, may be a random access memory or any other suitable volatile or non-volatile storage device. Persistent storage 608 may take various forms depending on the particular implementation. For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608. When identity information is input into computing device 600, the identity information is stored in memory 606 or persistent storage 608.

Communications unit 610, in these examples, provides for communications with other data processing systems or devices. Communications unit 610 may provide communications through the use of either or both physical and wireless communications links. In one embodiment, communications unit 610 is a network interface card. Communications unit 610 may also comprise a transmitter device for wirelessly transmitting identity information stored in memory 606 or persistent storage 608 to another device, such as identification badge 402 in FIG. 4. The transmitter may comprise an IR transmitter or an RF transmitter.

Input/output unit 612 allows for input and output of data with other devices that may be connected to data processing system 600. For example, input/output unit 612 may provide a connection for user input through a keyboard and mouse. Further, input/output unit 612 may send output to a printer. Display 614 provides a mechanism to display information to a user.

The different components illustrated for computing device 600 are not meant to provide architectural limitations to the manner in which different embodiments may be implemented. The different illustrative embodiments may be implemented in a data processing system including components in addition to or in place of those illustrated for computing device 600. Other components shown in FIG. 6 can be varied from the illustrative examples shown.

In another example, a bus system may be used to implement communications fabric 602 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter.

Further, a memory may be, for example, memory 606 or a cache such as found in an interface and memory controller hub that may be present in communications fabric 602.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An identification badge, comprising:
at least one organic light emitting diode display device for displaying identification information about a user associated with the identification badge;
one or more buttons affixed to the identification badge for selection by the user, wherein selection of a first button in the one or more buttons by the user conceals visibility of the identification information displayed in the at least one organic light emitting diode display device, and wherein selection of a second button in the one or more buttons by the user enables the identification information concealed from display in the at least one organic light emitting diode display device to be visible.

2. The identification badge of claim 1, wherein the identification information represents a level of security access associated with the user.

3. The identification badge of claim 1, wherein the identification information specifies at least one of a name, employee identifier, or associated organization of the user.

4. The identification badge of claim 1, wherein the identification information is displayed in the at least one organic light emitting diode display device using graphical images and textual images.

5. The identification badge of claim 1, further comprising:
a memory for storing the identification information; and
a processing unit for executing instructions to update the identification information displayed in the at least one organic light emitting diode display device.

6. The identification badge of claim 5, further comprising:
an encryption mechanism for preventing unauthorized access to the identification information stored in the memory.

7. The identification badge of claim 5, wherein the instructions to update the identification information is received from a remote computing device.

8. A method for displaying identification information in an identification badge, the method comprising:
using at least one organic light emitting diode display device in the identification badge to display identification information about a user associated with the identification badge;
responsive to receiving user input from a first button affixed to the identification badge, concealing visibility of the identification information displayed in the at least one organic light emitting diode display device; and
responsive to receiving user input from a second button affixed to the identification badge, displaying the identification information in the at least one organic light emitting diode display device.

9. The method of claim 8, wherein the identification information represents a level of security access associated with the user.

10. The method of claim 8, wherein the identification information specifies at least one of a name, employee identifier, or associated organization of the user.

11. The method of claim 8, wherein the identification information is displayed in the at least one organic light emitting diode display device using graphical images and textual images.

12. The method of claim 8, further comprising:
receiving instructions to update the identification information in the identification badge;
updating the identification information displayed in the at least one organic light emitting diode display device.

13. The method of claim 12, wherein the instructions to update the identification information is received from a remote computing device.
